(19) United States
(12) Patent Application Publication
(10) Pub. No.: US 2025/0110720 A1
(43) Pub. Date: Apr. 3, 2025

(54) SYSTEM AND METHOD FOR MANAGING DISTRIBUTED CLIENT SOFTWARE UPDATES USING STATELESS DISTRIBUTED KUBERNETES SERVERS

(71) Applicant: VMware, Inc., Palo Alto, CA (US)

(72) Inventors: David Mark William Byard, Ellicott City, MD (US); Praagyan Pokharel, Medford, MA (US); Benjamin Duong, Medford, MA (US); Ron Passerini, Somerville, MA (US)

(21) Appl. No.: 18/374,545

(22) Filed: Sep. 28, 2023

(51) Int. Cl. G06F 8/65

(52) U.S. Cl. CPC G06F 8/65

(57) ABSTRACT

System and computer-implemented method for updating applications running in a distributed computing system uses an update agent associated with an existing application to make a request for update information regarding the existing application to a service to receive a response that includes a target version of the existing application and an update window of time, which is based on information contained in the request for update information. A deployment of the target version of the existing application within the update window of time is coordinated by the update agent when the target version is newer than a current version of the existing application.

### BACKGROUND

Software-defined data center (SDDC) is an architectural approach based on virtualization and automation, which drives many of current leading data centers. In an SDDC, the infrastructure is virtualized, and the control of the SDDC is entirely automated by software. In some implementations, a cloud-based service may provide management and/or support for the SDDC. Thus, in a computing environment with one or more SDDCs, such as a private, public or multiple (e.g., hybrid) cloud environment, there may be a need to update one or more components in the SDDCs from the cloud-based service. Thus, there is a need to efficiently manage the updating of these components in the different SDDCs.

### SUMMARY

System and computer-implemented method for updating applications running in a distributed computing system uses an update agent associated with an existing application to make a request for update information regarding the existing application to a service to receive a response that includes a target version of the existing application and an update window of time, which is based on information contained in the request for update information. A deployment of the target version of the existing application within the update window of time is coordinated by the update agent when the target version is newer than a current version of the existing application.

A computer-implemented method for updating applications running in a distributed computing system in accordance with an embodiment of the invention comprises for an existing application running in the distributed computing system, making a request for update information regarding the existing application to a service by an update agent associated with the existing application, receiving a response from the service by the update agent, wherein the response includes a target version of the existing application and an update window of time based on information contained in the request for update information, when the target version is newer than a current version of the existing application, and coordinating a deployment of the target version of the existing application within the update window of time by the update agent. In some embodiments, the steps of this method are performed when program instructions contained in a computer-readable storage medium are executed by at least one processor.

A system in accordance with an embodiment of the invention comprises memory and at least one processor configured to, for an existing application running in a distributed computing system, make a request for update information regarding the existing application to a service by an update agent associated with the existing application, receive a response from the service by the update agent, wherein the response includes a target version of the existing application and an update window of time based on information contained in the request for update information, when the target version is newer than a current version of the existing application, and coordinate a deployment of the target version of the existing application within the update window of time by the update agent.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 illustrates a distributed computing system with a cloud-based service, a transport service and a number of software-defined data centers (SDDCs) in accordance with an embodiment of the invention.

FIG. 2 is a diagram of an SDDC that can be deployed in the distributed computing system in accordance with an embodiment of the invention.

FIG. 3 shows components of a transport client that includes a client application that may need updating in accordance with an embodiment of the invention.

FIG. 4 is a flow diagram of a high-level ongoing process of updating a client application in each transport client in the distributed computing system in accordance with an embodiment of the invention.

FIG. 5 is a diagram of a process of updating a client application of a transport client in the distributed computing system in accordance with an embodiment of the invention.

FIG. 6 is a flow diagram of a process of upgrading a Hypertext Transfer Protocol (HTTP) connection to a websocket for a client application in the distributed computing system in accordance with an embodiment of the invention.

FIG. 7 is a flow diagram of a process of shutting down a client application when a request for clean shutdown is received in accordance with an embodiment of the invention.

FIG. 8 is a flow diagram of a computer-implemented method for updating applications running in a distributed computing system in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Embodiments of the invention are directed to managing distributed client software updates using stateless distributed servers. The distributed client software can be any type of applications that can be accessed by the servers. The distributed client applications are described herein as being in a particular implementation. However, these client applications may be in a different implementation.

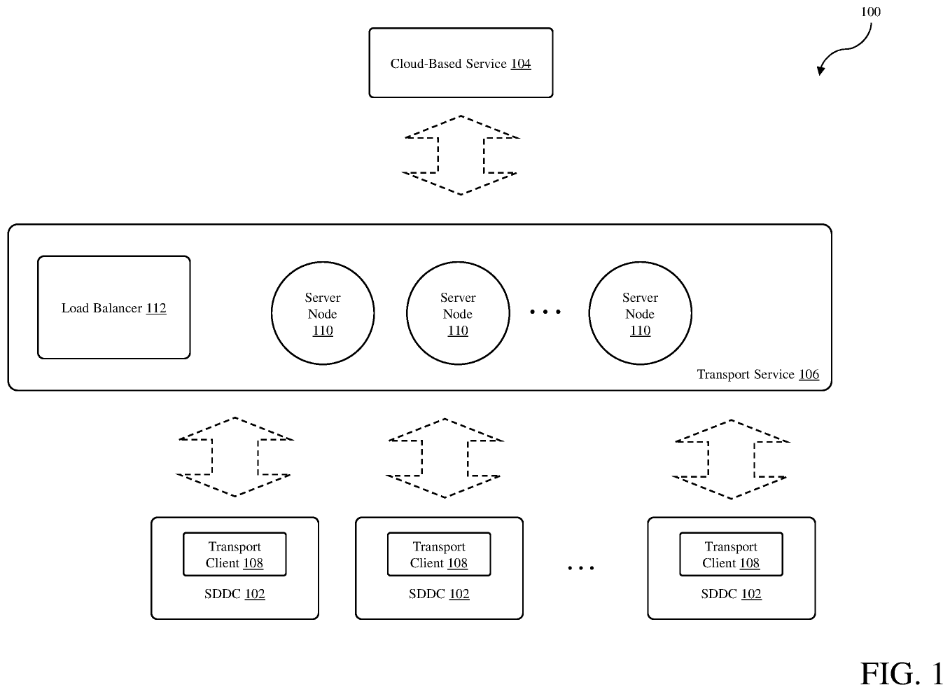

Turning now to FIG. 1, a distributed computing system 100 in accordance with an embodiment of the invention is illustrated. The distributed computing system 100 includes a plurality of software-defined data centers (SDDCs) 102, a cloud-based service 104 and a transport service 106. As described in detail below, communication connections are made between the cloud-based service 104 and the SDDCs 102 via the transport service 106 so that the cloud-based service can communicate with any of the SDDCs for various operations. In an embodiment, the SDDCs 102 are orchestrated and managed by the cloud-based service 104, and thus, the communication connections are used by the cloud-based service to access the SDDCs to execute orchestration and management operations.

Each SDDC 102 in the distributed computing system 100 may be running in an on-premise computing environment (sometimes referred to herein as a private cloud computing environment or simply a private cloud), in a public cloud computing environment (or simply a public cloud) or in a hybrid cloud (a combination of private and public clouds). These SDDCs 102 may be owned and operated by different business entities, such as business enterprises. As shown in FIG. 1, each of the SDDCs 102 includes a transport client 108, as well as other components (not shown in FIG. 1), which enables connectivity with the cloud-based service 104 via the transport service 106 so that the cloud-based service can communicate with a target resource in the SDDC 200. These distributed transport clients 108 in the SDDCs include client software or applications that need to be updated when new versions are available, as described in more detail below.

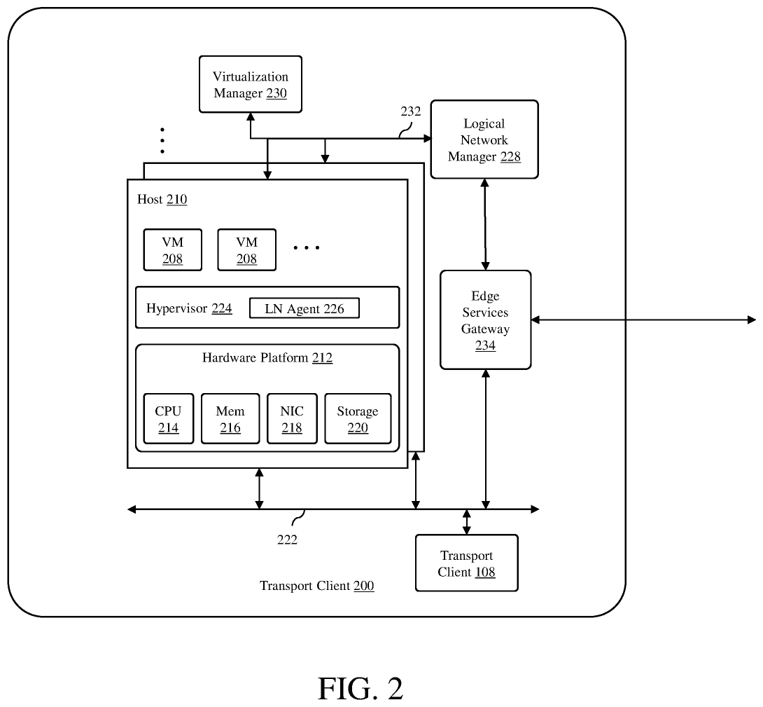

Turning now to FIG. 2, a representative SDDC 200 that can be deployed in the distributed computing system 100 in accordance with an embodiment of the invention is illustrated. Thus, the SDDC 200 is an example of the SDDCs 102 depicted in FIG. 1. As shown in FIG. 2, the SDDC 200 includes one or more host computer systems (“hosts”) 210. The hosts may be constructed on a server grade hardware platform 212, such as an x86 architecture platform. As shown, the hardware platform of each host may include conventional components of a computing device, such as one or more processors (e.g., CPUs) 214, system memory 216, a network interface 218, and storage 220. The processor 214 can be any type of a processor commonly used in servers. The memory 216 is volatile memory used for retrieving programs and processing data. The memory 216 may include, for example, one or more random access memory (RAM) modules. The network interface 218 enables the host 210 to communicate with other devices that are inside or outside of the SDDC 200 via a communication medium, such as a network 222. The network interface 218 may be one or more network adapters, also referred to as network interface cards (NICs). The storage 220 represents one or more local storage devices (e.g., one or more hard disks, flash memory modules, solid state disks and/or optical disks), which may be used to form a virtual storage area network (SAN).

Each host 210 may be configured to provide a virtualization layer that abstracts processor, memory, storage and networking resources of the hardware platform 212 into virtual computing instances, e.g., virtual machines 208, that run concurrently on the same host. The virtual machines run on top of a software interface layer, which is referred to herein as a hypervisor 224, that enables sharing of the hardware resources of the host by the virtual machines. One example of the hypervisor 224 that may be used in an embodiment described herein is a VMware ESXi™ hypervisor provided as part of the VMware vSphere® solution made commercially available from VMware, Inc. The hypervisor 224 may run on top of the operating system of the host or directly on hardware components of the host. For other types of virtual computing instances, the host may include other virtualization software platforms to support those virtual computing instances, such as Docker virtualization platform to support “containers.” In the following description, the virtual computing instances 208 will be described as being virtual machines.

In the illustrated embodiment, the hypervisor 224 includes a logical network (LN) agent 226, which operates to provide logical networking capabilities, also referred to as “software-defined networking” (SDN). Each logical network may include software managed and implemented network services, such as bridging, L3 routing, L2 switching, network address translation (NAT), and firewall capabilities, to support one or more logical overlay networks in the SDDC 200. The logical network agent 226 receives configuration information from a logical network manager 228 (which may include a control plane cluster) and, based on this information, populates forwarding, firewall and/or other action tables for dropping or directing packets between the virtual machines 208 in the host 210, other virtual machines on other hosts, and/or other devices outside of the SDDC 200. Collectively, the logical network agent 226, together with other logical network agents on other hosts, according to their forwarding/routing tables, implement isolated overlay networks that can connect arbitrarily selected virtual machines with each other. Each virtual machine may be arbitrarily assigned a particular logical network in a manner that decouples the overlay network topology from the underlying physical network. Generally, this is achieved by encapsulating packets at a source host and decapsulating packets at a destination host so that virtual machines on the source and destination can communicate without regard to underlying physical network topology. In a particular implementation, the logical network agent 226 may include a Virtual Extensible Local Area Network (VXLAN) Tunnel End Point or VTEP that operates to execute operations with respect to encapsulation and decapsulation of packets to support a VXLAN backed overlay network. In alternate implementations, VTEPs support other tunneling protocols such as stateless transport tunneling (STT), Network Virtualization using Generic Routing Encapsulation (NVGRE), or Geneve, instead of, or in addition to, VXLAN.

The SDDC 200 also includes a virtualization manager 230 that communicates with the hosts 210 via a management network 232. In an embodiment, the virtualization manager 230 is a computer program that resides and executes in a computer system, such as one of the hosts, or in a virtual computing instance, such as one of the virtual machines 208 running on the hosts. One example of the virtualization manager 230 is the VMware vCenter Server® product made available from VMware, Inc. In an embodiment, the virtualization manager is configured to carry out administrative tasks for a cluster of hosts that forms an SDDC, including managing the hosts in the cluster, managing the virtual machines running within each host in the cluster, provisioning virtual machines, migrating virtual machines from one host to another host, and load balancing between the hosts in the cluster.

As noted above, the SDDC 200 also includes the logical network manager 228 (which may include a control plane cluster), which operates with the logical network agents 226 in the hosts 210 to manage and control logical overlay networks in the SDDC 200. Logical overlay networks comprise logical network devices and connections that are mapped to physical networking resources, e.g., switches and routers, in a manner analogous to the manner in which other physical resources as compute and storage are virtualized. In an embodiment, the logical network manager 228 has access to information regarding physical components and logical overlay network components in the SDDC. With the physical and logical overlay network information, the logical network manager 228 is able to map logical network configurations to the physical network components that convey, route, and filter physical traffic in the SDDC 200. In one particular implementation, the logical network manager 228 is a VMware NSX® product running on any computer, such as one of the hosts or a virtual machine in the SDDC 200.

The SDDC 200 also includes a gateway 234 to control network traffic into and out of the SDDC 200. In an embodiment, the gateway 234 may be implemented in one of the virtual machines 208 running in the SDDC 200. In a particular implementation, the gateway 234 may be an edge services gateway. One example of the edge services gateway 234 is VMware NSX® Edge™ product made available from VMware, Inc.

As noted above, the SDDC 200 also includes the transport client 108, which works with the transport service 106 to provide connectivity for the cloud-based service 104 to communicate with a target resource in the SDDC 200, such as the virtualization manager 230. In some embodiments, the SDDC 200 may include more than one transport client. Although shown as an individual component, the transport client 108 may be running on one of the hosts 210 or in one of the VMs 208 in the hosts. The transport client 108 will be described in more detail below.

Turning back to FIG. 1, as noted above, the cloud-based service 104 of the distributed computing system 100 is configured or programmed to access the SDDCs 102 to execute various operations. As an example, the cloud-based service 104 may be configured or programmed to deploy, update, delete and otherwise manage components in the SDDCs 102. The cloud-based service 104 may also be configured or programmed to manage allocation of virtual computing resources to the SDDCs 102. In an embodiment, the cloud-based service 104 may be configured or programmed to be accessible to authorized users via a REST (Representational State Transfer) API (Application Programming Interface) or any other client-server communication protocol so that various operations can be executed at the SDDCs 102. As an example, the cloud-based service 104 may be a VMware vCloud Director® service from VMware, Inc., which may be running on VMware cloud (VMC) on Amazon Web Services (AWS).

The transport service 106 of the distributed computing system 100 is configured or programmed to connect the cloud-based service 104, as a reverse proxy client, to the SDDCs 102. In order to provide connectivity for the cloud-based service 104 to more than one of the SDDCs 102, the transport service 106 includes a cluster of transport server nodes 110. Each of these transport server nodes 110 can establish a communication connection with one of the SDDCs 102 via the transport client 108 running on that SDDC in a server-client relationship. In addition, each of these transport server nodes 110 can handle a connection request from the cloud-based service 104 to access a target resource in a particular SDDC.

The selection of a transport server node from the available transport server nodes 110 in the transport service 106 to establish a communication channel with a particular SDDC 102 is made by a load balancer 112 running in the transport service. In addition, the selection of a transport server node from the available transport server nodes in the transport service in response to a connection request from the cloud-based service 104 for a target resource in a particular SDDC is also made by the load balancer. In an embodiment, these transport server node selections are made by the load balancer in random or without regards to any established communication channels or connections with the transport clients 108 in the SDDCs so that the various connection requests are distributed among the available transport server nodes 110 in the transport service 106. In an embodiment, the transport server nodes may be implemented as a high performance computing (HPC) cluster. In some embodiments, the transport server nodes may be implemented as Kubernetes pods in a Kubernetes system running on a public cloud.

In an embodiment, the transport server nodes 110 in the transport service 106 are stateless servers. Thus, no information regarding the transport server nodes 110 is persistently stored on any non-volatile memory. As an example, information regarding any established communication channels between the transport server nodes 110 and the transport clients 108 in the SDDCs 102 is not persistently stored. In addition, information regarding the transport server nodes handling connection requests from the cloud-based service 104 is also not persistently stored. Also, information regarding connectivity paths (including any jumps between the transport server nodes) through the transport server nodes is not persistently stored.

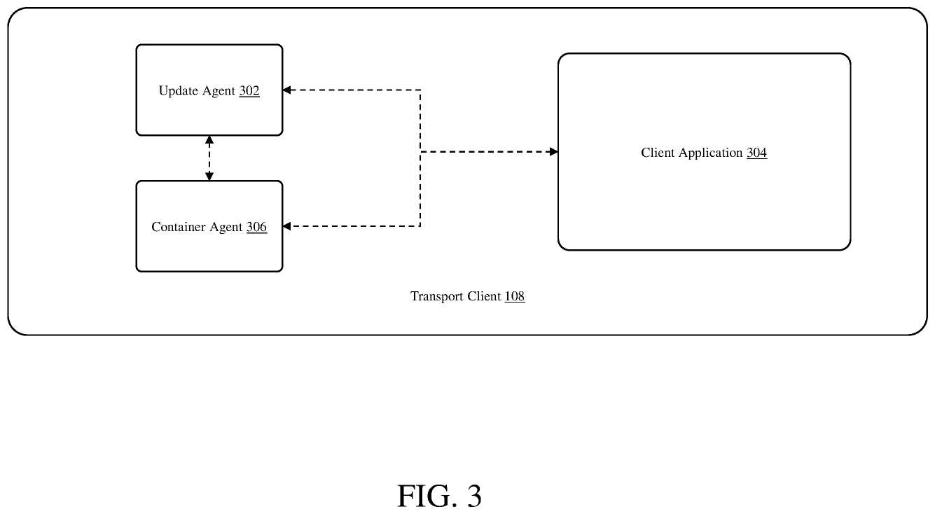

Turning now to FIG. 3, components of the transport client 108 in accordance with an embodiment of the invention are illustrated. In this embodiment, the transport client 108 is a VM running on one of the hosts 210 in the distributed computing system 100. As shown in FIG. 3, the transport client 108 includes an update agent 302 and a client application 304. The client application 304 is the software that may need to be updated, which is managed by the update agent 302 as described below. The client application 304 may be running in a container, such as a Docker container, which is running in the transport client 108 (i.e., in a VM). Thus, the client application 304 may be running in one or more container namespaces. In such an embodiment, the transport client 108 may include a container agent 306, which manages deployment of the client application 304 and also maintains information regarding the deployed client application, as described below. In this embodiment, the client application 304 is designed or programmed to interface with the cloud-based service 104 so that the cloud-based service can continuously access resources in the SDDC 102 in which the client application is running with no requirement for any inbound connectivity. These resources may be other components in the SDDC 102 such as the logical network manager 228 and the virtualization manager 230.

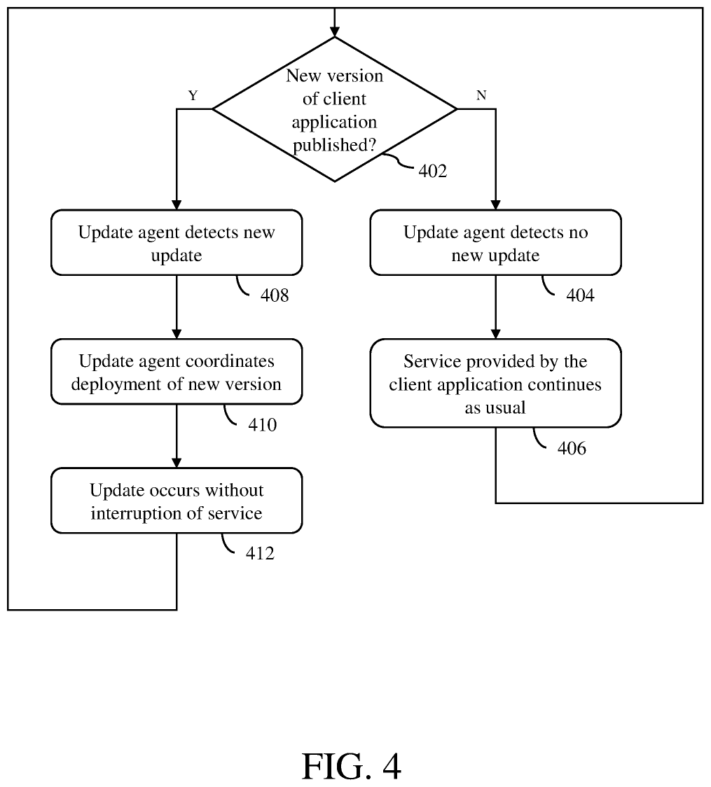

A high-level ongoing process of updating a client application 304 in each transport client 108 in the distributed computing system 100 when a new version of the client application is published in accordance with an embodiment of the invention is described with reference to a process flow diagram shown in FIG. 4. At step 402, a new version of the client application 304 may be published. In addition, information about the new version is provided to all the server nodes 110 of the transport service 106. In an embodiment, the new version is published at a website that can be reached by any of the transport clients to upgrade their client applications. Thus, the information about the new version may include the address of the website to download the new version of the client application for upgrade. If a new version of the client application has not been published, then the process proceeds to step 404.

At step 404, no new update of the client application 304 is detected by the update agent 302 of the transport client 108 since a new version of the client application has not been published. Next, at step 406, the service provided by the existing client application is continued as usual. The process then proceeds back to step 402, where a new version of the client application may be published.

If a new version of the client application 304 has been published, then the process proceeds to step 408, where the new update of the client application is detected by the update agent 302 since a new version of the client application has been published. Next, at step 410, a deployment of the new client application version is coordinated by the update agent 302 to update the existing client application in the transport client 108. Next, at step 412, the updating of the existing client application occurs without any interruption of the service being provided by the existing client application. The process then proceeds back to step 402, where a newer version of the client application may be published.

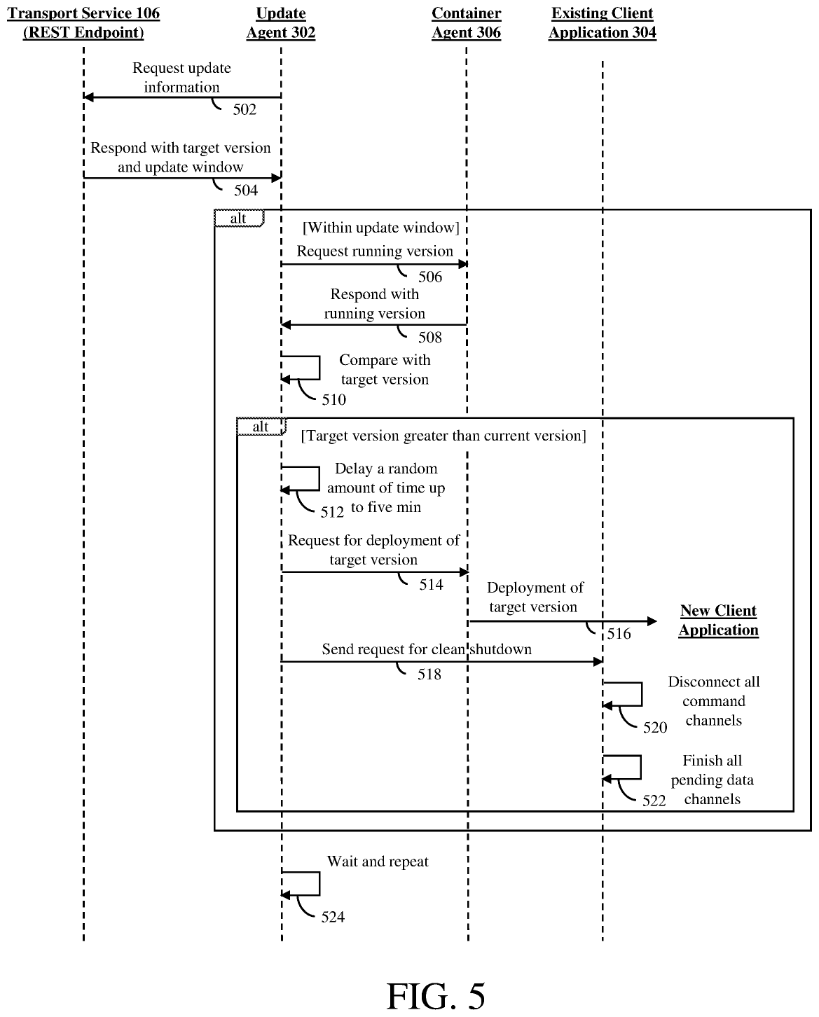

A process of updating the client application 304 of one of the transport clients 108, which is facilitated by the update agent 302 in that transport client, in accordance with an embodiment of the invention is described with reference to a diagram shown in FIG. 5. The process begins at step 502, where the update agent 302 in the transport client 108 requests for client application update information from the transport service 110. Next, at step 504, a response with a target version of the client application and an update window is transmitted back to the update agent from the transport service 110. The target version is the latest version of the client application or software. The update window is the window of time for updating, if needed.

In an embodiment, the transport service 106 exposes a single application programming interface (API) or Representational State Transfer (REST) endpoint, e.g., a Hypertext Transfer Protocol (HTTP) endpoint at the path “/upgrade”. As an example, this endpoint may take the following three query parameters as requests for client application update information:

| Name | Purpose | Example |
|---|---|---|
| organizationId | The organization ID that the | 021361e4-9d4c-4421- |
| | client uses for authentication | 837c-c11e51d61a9f |
| networkName | The network identifier that the | us-sddc-1 |
| | client uses for authentication | |
| clientIdentifier | A user configured client | transporter-0 |
| | identifier | |

In an embodiment, the endpoint returns a Javascript Object Notation (JSON) response that looks like the following:

```
[
  {
      ″component″: ″com.vmware.cloud.transporter.client″,
      updated″: 1234567890,
      ″target Version″: ″ob-1234567890″,
      ″suggestedUpdateWindow″: {
      ″notBefore″: 1234567890,
      ″notAfter″: 1234567895
    }
  }
]
```

The fields in the returned object are described in the following table:

| Name | Purpose |
|---|---|
| Component | Expresses the component being updated (never |
| | changes) |
| Timestamp | Java timestamp that the component was updated |
| | (this will be the application start timestamp) |
| Version | The version that should be updated to (this will |
| | be the server version) |
| suggestedUpdateWindow. | Java timestamp before which updates should not |
| notBefore | be performed (milliseconds from epoch) |
| suggestedUpdateWindow. | Java timestamp after which updates should not |
| notAfter | be performed (milliseconds from epoch) |

The “suggestedUpdateWindow.notBefore” and “suggestedUpdateWindow.notAfter” of the returned object define the update window for the requesting update agent.

In an embodiment, update windows, e.g., 15 minute time windows, are generated at the endpoint provided by the transport service 106 so that each client identifier for any given organization/network will be spread out fairly evenly from a predefined time, e.g., the next 2 AM Coordinated Universal Time (UTC). However, in other embodiments, the update window size can be a length of time other than 15 minutes and the predefined time can be any time in any time zone.

A hash-based algorithm for determining a 15-minute update widow in accordance with an embodiment of the invent is now described. First, a NOW value is determined. The NOW value can be any arbitrary time for the current time. Then, the NOW value is switched to an UTC value, which is set as a BASE value. Next, the hour, minute, second and nanosecond of the NOW value are set to the predetermined UTC base time, e.g., 2 AM UTC. The day is then divided into equal millisecond windows based on the number of buckets or windows for a day, i.e., ninety-six (96) 15-minute windows. This window size in milliseconds is set as a SIZE value. Next, the SIZE value is multiplied by the given bucket index and added to the BASE value. The resulting time value is set as a START value. The given bucket index is a unique value from one to the number of windows for a day, e.g., ninety-six (96). In an embodiment, the given bucket index for a request from an update agent is computed by generating a hash of the information from the update agent, e.g., the organizationId, networkName and clientIdentifier, and then calculating the modulo the number of windows for a day, e.g., ninety-six (96), for the hashed value, i.e., N modulo M, where N is the hashed value and M is the number of windows for a day.

The SIZE value is then added to the START value, which is set as an END value. If the END value is after the NOW value, (START, END) is then returned as the update window for updating the client application, which includes downloading the latest version of the client application. Otherwise (that is the END value is before the NOW value), (START+1 day, END+1 day) is then returned as the update window for updating the client application.

In this embodiment, a day is used to divide the update windows of time. However, in other embodiments, a different period of time may be used to divide the update windows of time, e.g., 48 hours or a week.

Turning back to the updating process illustrated in FIG. 5, if the current time is within the update window, steps 506-510 are performed. If not, then the process proceeds to step 524, where the updating process is again initiated by the update agent after waiting until the next scheduled time to make another request.

At step 506, a request for the running version of the client application 304 is transmitted from the update agent 302 to the container agent 306. Next, at step 508, a response with the running version of the existing client application is transmitted back to the update agent 302 from the container agent 306. Next, at step 510, the running version of the existing client application is compared with the target version of the client application by the update agent 302.

If the target version is greater than the current or running version, i.e., the target version is newer than the current version, then steps 514-522 are performed. If not, then the process proceeds to step 524, where the updating process is again initiated by the update agent after waiting until the next scheduled time to make another request.

At step 512, a random delay is introduced by the update agent 302. As an example, a random amount of delay time up to a fixed time, e.g., 5 minutes, is allowed to pass before taking further action by the update agent. This jitter may help prevent two updates occurring simultaneously in the distributed computing system 100.

Next, at step 514, a request for deployment of the target version of the client application is transmitted to the container agent 306 from the update agent 302. Next, at step 516, in response to the deployment request, a new client application is deployed by the container agent 306, e.g., in one or more container namespaces in the transport client 108.

Next, at step 518, a request for clean shutdown is transmitted to the existing client application 304 by the update agent 302 so that the new client application can take over handling new communication data. Next, at step 520, in response to the shutdown request, all command channels are disconnected by the existing client application. In addition, at step 522, all pending data channels are finished by the existing client application. The shutdown process for the existing application is now complete. The process then proceeds to step 524, where the updating process is again initiated by the update agent after waiting until the next scheduled time to make another request.

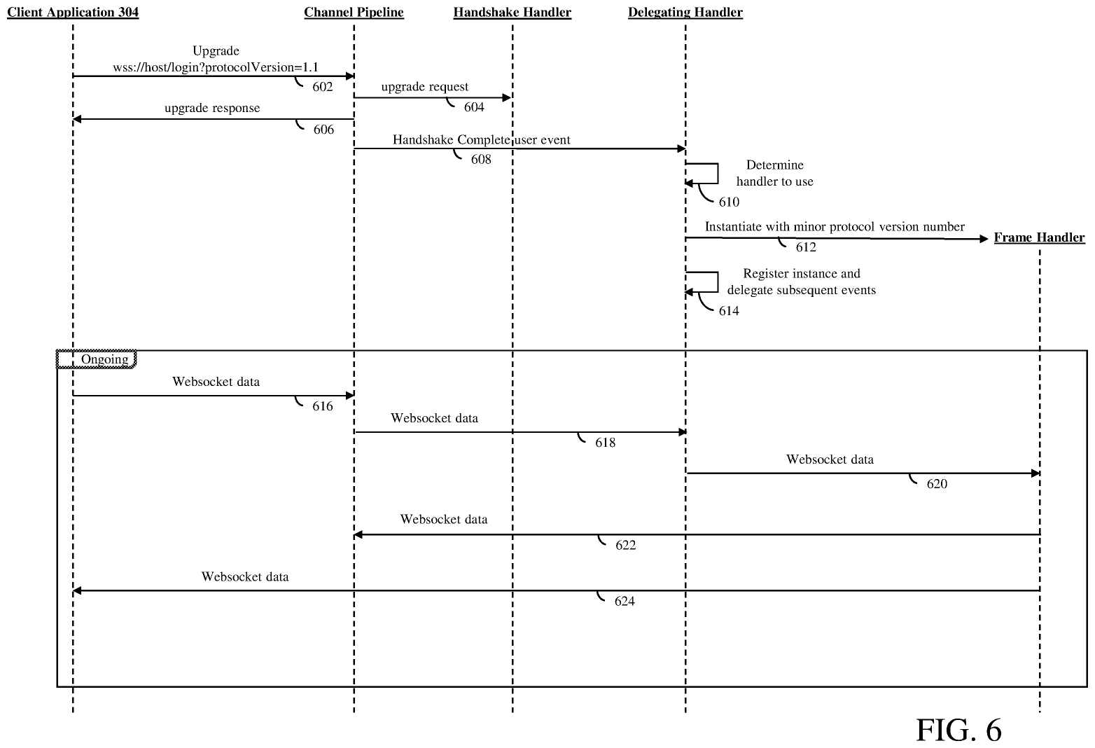

In an embodiment, each client application 304 is initially connected to the transport service 106 via an HTTP connection and then upgraded to a websocket, which allows both the existing client application and the new client applications to have simultaneous connection to the transport service. A process of upgrading an HTTP connection to a websocket for a client application 304 in the distributed computing system 100 in accordance with an embodiment of the invention is described with reference to a process flow diagram shown in FIG. 6. For this process, in this embodiment, a number of handlers in the transport service 106 are involved in the process. These handlers include a channel pipeline, a websocket server protocol handshake handler (simply referred to herein as the “handshake handler”), a command channel protocol delegating handler (simply referred to herein as the “delegating handler”) and a reverse proxy command frame handler (simply referred to herein as the “frame handler”). The channel pipeline is a group of handlers that operate to handle requests for websockets from client applications in the distributed computing system 100.

The process begins at step 602, where a websocket upgrade request is made to the channel pipeline of the transport service 106 from the client application 304, which has a major protocol number and a minor protocol number that are unique to each client application. In an embodiment, this websocket upgrade request is made using a Uniform Resource Locator (URL) request, which provides a natural number major version number and a whole number minor version number via query strings, as specified below.

| Websocket URL | Major Version | Minor Version | Comment |
|---|---|---|---|
| /login | 1 (legacy) | 0 (legacy) | Assume major version 1, minor |
| | | | version 0 for backwards |
| | | | compatibility |
| /login?protocolVersion=0 | <bad request> | <bad request> | Major/minor version missing |
| /login?protocolVersion=0.1 | <bad request> | <bad request> | Major version not a natural |
| | | | number |
| /login?protocolVersion=1.-1 | <bad request> | <bad request> | Minor version not a whole |
| | | | number |
| /login?protocolVersion=1.1.2 | <bad request> | <bad request> | Major version not a natural |
| | | | number/minor version not a |
| | | | whole number |
| /login?protocolVersion=1.0 | 1 | 0 | |
| /login?protocolVersion=1.1 | 1 | 1 | |
| /login?protocolVersion=32.15 | 32 | 15 | |

Next, at step 604, in response to the websocket request, an upgrade request is sent to the handshake handler of the transport service 106 from the channel pipeline. Next, at step 606, a response to the upgrade information is sent back to the client application by the channel pipeline. As an example, the response can be either “success” or “failure” with respect to the websocket upgrade request.

Next, at step 608, a handshake complete user event is transmitted from the channel pipeline to the delegating handler. Next, at step 610, a suitable handler for the major version, which may be provided in a Uniform Resource Identifier (URI) of the event, is selected by the delegating handler. Next, at step 612, a suitable frame handler is instantiated by the delegating handler using the minor protocol version number. Next, at step 614, the instance of the frame handler is registered and subsequent events are delegated to the instance.

As an ongoing operation, steps 616-624 are performed. At step 616, websocket data is transmitted to the channel pipeline from the client application. Next, at step 618, the websocket data is sent from the channel pipeline to the delegating handler. Next, at step 620, the websocket data is delegated to the frame handler by the delegating handler.

In response to the received websocket data, response websocket data is transmitted to the channel pipeline by the frame handler, at step 622. In addition, at step 624, the response websocket data is also transmitted to the client application by the frame handler.

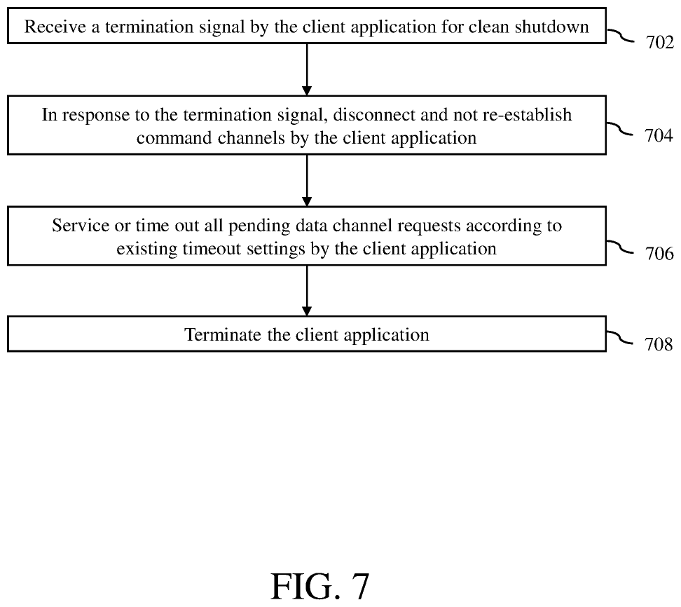

A process of shutting down a client application 304 when a request for clean shutdown is received in accordance with an embodiment of the invention is described with reference to a process flow diagram shown in FIG. 7. The process begins at step 702, where a termination signal is received by the client application for clean shutdown as part of the updating process. Next, at step 704, in response to the termination signal, command channels are disconnected and not re-established by the client application. Next, at step 706, all pending data channel requests are serviced or timed out according to existing timeout settings by the client application. Next, at step 708, the client application is terminated or shut down, i.e., no longer operating.

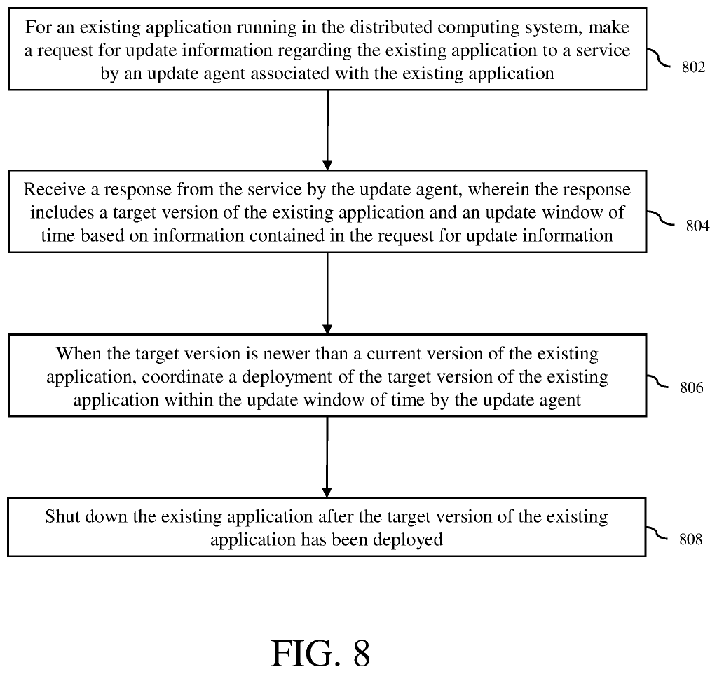

A computer-implemented method for updating applications running in a distributed computing system in accordance with an embodiment of the invention is described with reference to a process flow diagram of FIG. 8. At block 802, for an existing application running in the distributed computing system, a request for update information regarding the existing application is made to a service by an update agent associated with the existing application. At block 804, a response from the service is received by the update agent. The response includes a target version of the existing application and an update window of time based on information contained in the request for update information. At block 806, when the target version is newer than a current version of the existing application, a deployment of the target version of the existing application within the update window of time is coordinated by the update agent. At optional block 808, the existing application is shut down after the target version of the existing application has been deployed.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer usable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for updating applications running in a distributed computing system, the method comprising:
for an existing application running in the distributed computing system, making a request for update information regarding the existing application to a service by an update agent associated with the existing application;
receiving a response from the service by the update agent, wherein the response includes a target version of the existing application and an update window of time based on information contained in the request for update information; and
when the target version is newer than a current version of the existing application, coordinating a deployment of the target version of the existing application within the update window of time by the update agent.

2. The computer-implemented method of claim 1, further comprising computing the update window of time using a bucket index derived from N modulo M, where N is a hash of the information contained in the request for update information and M is a total number of update windows of time for a specified period of time.

3. The computer-implemented method of claim 2, wherein computing the update window of time includes defining a start value that corresponds to a product of the bucket index and a size of the update windows of time and an end value that corresponds to the start value plus the size of the update windows of time, wherein the update window of time is set to be the start value and the end value when the end value is after a current time and wherein the update window of time is set to be the start value plus the specified period of time and the end value plus the specified period of time when the end value is before the current time.

4. The computer-implemented method of claim 1, wherein making the request for update information regarding the existing application includes making the request for update information regarding the existing application to an application programming interface (API) endpoint that is provided by the service.

5. The computer-implemented method of claim 4, wherein the API endpoint is a Hypertext Transfer Protocol (HTTP) endpoint.

6. The computer-implemented method of claim 1, wherein the response is a Javascript Object Notation (JSON) response that includes the target version and the update window of time.

7. The computer-implemented method of claim 1, wherein the existing application is running in a container within a virtual machine.

8. The computer-implemented method of claim 7, wherein the current version of the existing application is provided by a container agent in the virtual machine and the deployment of the target version of the existing application is performed by the container agent.

9. The computer-implemented method of claim 1, further comprising shutting down the existing application after the target version of the existing application has been deployed.

10. A non-transitory computer-readable storage medium containing program instructions for updating applications running in a distributed computing system, wherein execution of the program instructions by one or more processors causes the one or more processors to perform steps comprising:
for an existing application running in the distributed computing system, making a request for update information regarding the existing application to a service by an update agent associated with the existing application;
receiving a response from the service by the update agent, wherein the response includes a target version of the existing application and an update window of time based on information contained in the request for update information; and
when the target version is newer than a current version of the existing application, coordinating a deployment of the target version of the existing application within the update window of time by the update agent.

11. The non-transitory computer-readable storage medium of claim 10, wherein the steps further comprise computing the update window of time using a bucket index derived from N modulo M, where N is a hash of the information contained in the request for update information and M is a total number of update windows of time for a specified period of time.

12. The non-transitory computer-readable storage medium of claim 11, wherein computing the update window of time includes defining a start value that corresponds to a product of the bucket index and a size of the update windows of time and an end value that corresponds to the start value plus the size of the update windows of time, wherein the update window of time is set to be the start value and the end value when the end value is after a current time and wherein the update window of time is set to be the start value plus the specified period of time and the end value plus the specified period of time when the end value is before the current time.

13. The non-transitory computer-readable storage medium of claim 10, wherein making the request for update information regarding the existing application includes making the request for update information regarding the existing application to an application programming interface (API) endpoint that is provided by the service.

14. The non-transitory computer-readable storage medium of claim 13, wherein the API endpoint is a Hypertext Transfer Protocol (HTTP) endpoint.

15. The non-transitory computer-readable storage medium of claim 10, wherein the response is a Javascript Object Notation (JSON) response that includes the target version and the update window of time.

16. The non-transitory computer-readable storage medium of claim 10, wherein the existing application is running in a container within a virtual machine.

17. The non-transitory computer-readable storage medium of claim 16, wherein the current version of the existing application is provided by a container agent in the virtual machine and the deployment of the target version of the existing application is performed by the container agent.

18. A system comprising:
memory; and
at least one processor configured to:
for an existing application running in a distributed computing system, make a request for update information regarding the existing application to a service by an update agent associated with the existing application;
receive a response from the service by the update agent, wherein the response includes a target version of the existing application and an update window of time based on information contained in the request for update information; and
when the target version is newer than a current version of the existing application, coordinate a deployment of the target version of the existing application within the update window of time by the update agent.

19. The system of claim 17, wherein the at least one processor is further configured to compute the update window of time using a bucket index derived from N modulo M, where N is a hash of the information contained in the request for update information and M is a total number of update windows of time for a specified period of time.

20. The system of claim 18, wherein the at least one processor is further configured to define a start value that corresponds to a product of the bucket index and a size of the update windows of time and an end value that corresponds to the start value plus the size of the update windows of time, wherein the update window of time is set to be the start value and the end value when the end value is after a current time and wherein the update window of time is set to be the start value plus the specified period of time and the end value plus the specified period of time when the end value is before the current time.

21. The system of claim 17, wherein the at least one processor is configured to make the request for update information regarding the existing application to an application programming interface (API) endpoint that is provided by the service, and wherein the response from the API endpoint is a Javascript Object Notation (JSON) response that includes the target version and the update window of time.
